(19) United States
(12) Patent Application Publication
(10) Pub. No.: US 2015/0101735 A1
(43) Pub. Date: Apr. 16, 2015

(54) TRAY ASSEMBLY AND METHOD OF MANUFACTURING DONOR FILM USING THE SAME

(71) Applicant: SAMSUNG DISPLAY CO., LTD., Yongin-City (KR)

(72) Inventor: Kyong Tae Yu, Seongnam-si (KR)

(73) Assignee: SAMSUNG DISPLAY CO., LTD., Yongin-City (KR)

(21) Appl. No.: 14/258,990

(22) Filed: Apr. 22, 2014

(30) Foreign Application Priority Data
Oct. 15, 2013 (KR) 10-2013-0122911

(51) Int. Cl. B32B 38/00; B32B 37/12; B32B 37/06; B32B 37/16

(52) U.S. Cl. CPC B32B 38/0012; B32B 37/16; B32B 37/12; B32B 37/06; B32B 2038/0028; B32B 2310/028
USPC 156/73.1; 156/538; 156/494; 156/229

(57) ABSTRACT

A tray assembly configured to stretch an object film includes a main frame on which the object film is placed and a fixing unit at sides of the main frame and configured to couple the object film to the main frame. The fixing unit includes an adhesive film coupled to the object film thereby coupling the object film to the main frame.

### CROSS-REFERENCE TO RELATED APPLICATION

This patent application claims priority to and the benefit of Korean Patent Application No. 10-2013-0122911, filed on Oct. 15, 2013 in the Korean Intellectual Property Office, the entire content of which is hereby incorporated by reference.

### BACKGROUND

1. Field

Aspects of embodiments of the present disclosure are directed toward a tray assembly and a method of manufacturing a donor film using the same.

2. Description of the Related Art

An organic light emitting device, which is a flat panel display device, includes an anode electrode, a cathode electrode, and an intermediate layer between the anode electrode and the cathode electrode. The intermediate layer includes at least an organic light emitting layer. The intermediate layer further includes at least one organic layer including a hole injection layer, a hole transport layer, an electron transport layer, and/or an electron injection layer.

In the organic light emitting device, organic layers are patterned in order to realize a full-color display. As a patterning method, a shadow mask method is used to pattern a low molecular weight organic light emitting device, and an inkjet printing method or a laser induced thermal imaging (LITI) method is used to pattern a high molecular weight organic light emitting device.

When the organic layers are formed by utilizing the LITI method, a light source, an organic light emitting device substrate (e.g., an acceptor substrate), and a donor film are used. The donor film includes a base film, a light-to-heat conversion (LTHC) layer, and a transfer layer. Light emitted from the light source is absorbed by the LTHC layer and converted to heat energy by the LTHC layer. The converted heat energy causes a variation in an adhesive force between the LTHC layer, the transfer layer, and the acceptor substrate, and thus, a material utilized for the transfer layer formed on the donor film is transferred to the acceptor substrate. As a result, the organic layer pattern is formed on the acceptor substrate.

### SUMMARY

Aspects of embodiments of the present disclosure are directed toward a tray assembly capable of stably stretching a donor film and maintaining the stretched state.

Aspects of embodiments of the present disclosure are directed toward a method of manufacturing the donor film using the tray assembly.

Embodiments of the inventive concept include a tray assembly configured to stretch an object film, the tray assembly includes a main frame on which the object film is placed and a fixing unit along sides of the main frame, and configured to couple the object film to the main frame. The fixing unit includes an adhesive film coupled to the object film thereby coupling the object film to the main frame.

The adhesive film may be coupled to the object film by a welding process.

The welding process may include an ultrasonic welding process.

The adhesive film may include the same material as the object film.

The fixing unit may further include a fixing cover facing the main frame, and the adhesive film may include a fixing portion between and coupled to the main frame and the fixing cover and an adhesive portion that may include an upper surface coupled to the object film.

The fixing unit may further include a protruding bar under the adhesive portion of the adhesive film, and the adhesive portion of the adhesive film may be above an upper surface of the fixing cover.

The tray assembly may further include a stretching unit configured to stretch the object film in a first direction and a second direction opposite to the first direction, the protruding bar and the adhesive portion of the adhesive film may extend in a third direction substantially perpendicular to the first direction, and the object film may be coupled to the adhesive portion along the third direction.

The fixing cover may include first and second sub-fixing covers extending in the third direction and spaced from each other, the protruding bar may be between the first and second sub-fixing covers, and the fixing portion of the adhesive film may include a first fixing portion covered by the first sub-fixing cover and a second fixing portion covered by the second sub-fixing cover.

The protruding bar may contact the adhesive portion of the adhesive film and may have a curved surface.

The main frame may have a rectangular shape with first, second, third, and fourth sides, and the fixing unit may include first, second, third, and fourth fixing units at the first, second, third, and fourth sides of the main frame, respectively.

The tray assembly may further include a stretching unit at an outer position of each of the sides of the main frame, the stretching units may be at opposite ones of the sides facing each other, and may be mechanically coupled to the main frame, wherein the stretching unit may be configured to be moveable, and wherein the fixing unit may be on the stretching unit.

The main frame may have a rectangular shape with first, second, third, and fourth sides, the stretching unit may include first and second stretching units at the first and second sides of the main frame, may face each other, and may be configured to move in a first direction and a second direction opposite to the first direction, and the fixing unit may be at each of the first and second stretching units.

The stretching unit may further include third and fourth stretching units at the third and fourth sides of the main frame, may face each other, and may be configured to move in a third direction and a fourth direction opposite to the third direction, and the fixing unit may be at each of the third and fourth stretching units.

The object film may include a laser induced thermal imaging donor film coated by a transfer material.

Embodiments of the inventive concept include a method of manufacturing a donor film, the method including placing an object film on a main frame of a tray assembly, stretching the object film, and coupling the object film to a fixing unit at sides of the main frame. The coupling of the object film includes coupling an adhesive film on the fixing unit to the object film thereby coupling the object film to the main frame.

The coupling of the object film to the adhesive film may include an ultrasonic welding process.

The adhesive film may include the same material as the object film.

The object film may be stretched in a first direction, a second direction opposite to the first direction, a third direction substantially perpendicular to the first direction, and a fourth direction opposite to the third direction.

The main frame may include first sides extending in the first and second directions and second sides extending in the third and fourth directions, and a force stretching the object film in the first and second directions may be greater than a force stretching the object film in the third and fourth directions, and the first sides may be longer than the second sides.

The tray assembly may further include a stretching unit at an outer position of each of the sides of the main frame, may be mechanically coupled to the main frame, and may be configured to be moveable. The fixing unit may be on the stretching unit and the object film may be stretched by moving the stretching unit.

According to the above, the tray assembly may stably stretch the object film (e.g., the donor film) and maintain the stretched state of the object film.

### BRIEF DESCRIPTION OF THE DRAWINGS

The above and other features of the present disclosure will become more readily apparent by reference to the following detailed description when considered in conjunction with the accompanying drawings wherein:

FIG. 1 is a perspective view showing a tray assembly according to an example embodiment of the present disclosure;

FIG. 2 is a plan view showing the tray assembly shown in FIG. 1;

FIG. 3 is an enlarged perspective view showing a first fixing unit shown in FIG. 2;

FIG. 4 is a cross-sectional view taken along the line I-I′ of FIG. 2;

FIG. 5 is a side view showing a tray assembly according to an example embodiment illustrating an object film fixed to a main frame;

FIG. 6 is a perspective view showing a tray assembly according to another example embodiment of the present disclosure;

FIG. 7 is a plan view showing the tray assembly shown in FIG. 6;

FIG. 8 is a cross-sectional view taken along the line II-II′ of FIG. 7;

FIG. 9A is a side view showing an initial state of a tray assembly according to another example embodiment of the present disclosure; and

FIG. 9B is a side view showing a stretched state of a tray assembly according to another example embodiment of the present disclosure.

### DETAILED DESCRIPTION

It will be understood that when an element or layer is referred to as being “on”, “connected to”, or “coupled to” another element or layer, it can be directly on, connected, or coupled to the other element or layer or one or more intervening elements or layers may also be present. When an element is referred to as being “directly on,” “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Further, the use of “may” when describing embodiments of the present invention relates to “one or more embodiments of the present invention.”

Hereinafter, embodiments of the present invention will be explained in detail with reference to the accompanying drawings.

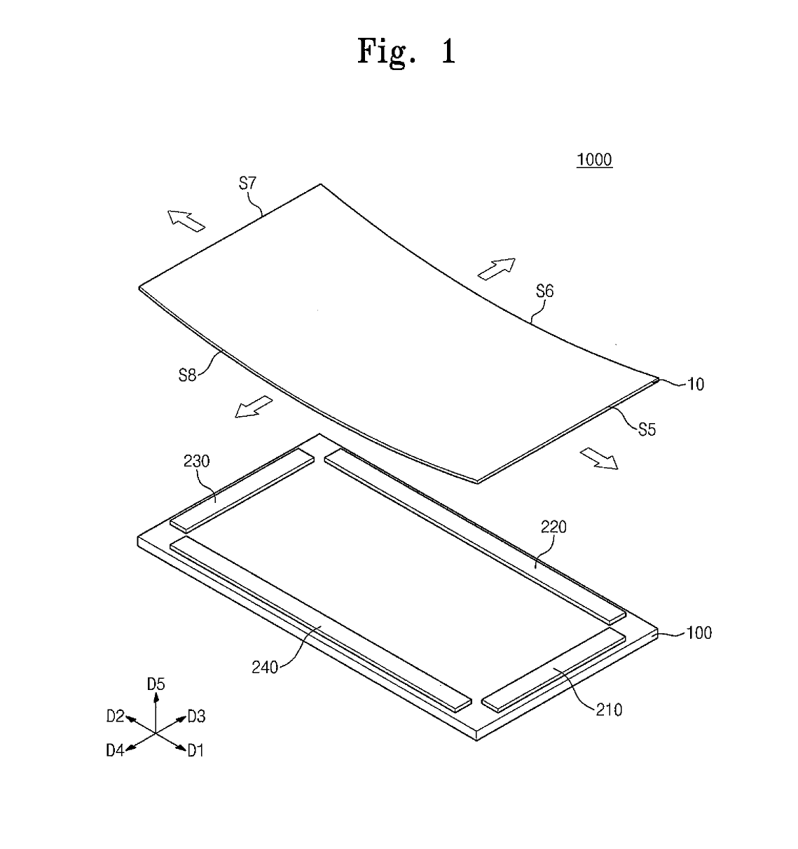

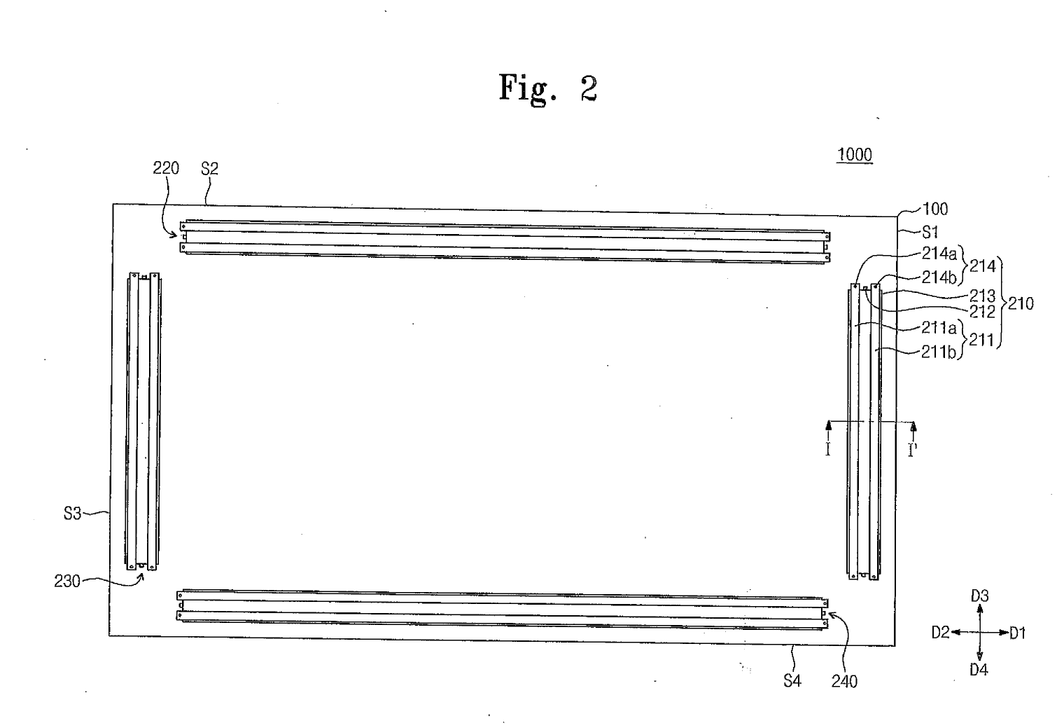

FIG. 1 is a perspective view showing a tray assembly according to an example embodiment of the present disclosure, and FIG. 2 is a plan view showing the tray assembly shown in FIG. 1.

Referring to FIGS. 1 and 2, a tray assembly 1000 includes a main frame 100 and first, second, third, and fourth fixing units 210, 220, 230, and 240. The tray assembly 1000 stretches and fixes an object film 10.

The object film 10 may be, but is not limited to, a donor film utilized in a laser induced thermal imaging (LITI) process. For example, the object film 10 includes at least one of a base film and/or a light-to-heat conversion layer. When the object film 10 is stretched by and fixed to the tray assembly 1000, various subsequent processes or acts, such as a process of forming a transfer layer including an organic material on the object film 10, a process of laminating the object film 10 on an acceptor substrate, etc., are performed.

When the object film 10 is formed of a flexible material, the object film 10 is curved or sags due to gravity. Accordingly, the subsequent processes are performed after the object film 10 is stretched to be substantially parallel to an upper surface of the main frame 100 and fixed to the main frame 100 by the first to fourth fixing units 210 to 240, thereby improving reliability of the subsequent processes. When the object film 10 is unstably fixed to the main frame 100, the subsequent processes are performed in a state where the object film 10 sags or is wrinkled. As a result, a defect occurs in the transfer layer and reliability and yield of the transfer layer forming process and the lamination process are reduced.

The main frame 100 has a shape corresponding to that of the object film 10, and the object film 10 is placed on or over the main frame 100. In the present example embodiment, the main frame 100 has a quadrangular shape with first, second, third, and fourth sides S1, S2, S3, and S4. For example, the main frame 100 has a rectangular shape with long sides (e.g., longer sides) and short sides (e.g., shorter sides). The first and third sides S1 and S3 are the short sides and the second and fourth sides S2 and S4 are the long sides.

Hereinafter, a direction substantially parallel to the long sides S2 and S4 of the main frame 100 is referred to as a first direction D1, and an other direction substantially parallel to the long sides S2 and S4 of the main frame 100, opposite to the first direction D1, is referred to as a second direction D2. In addition, an other direction substantially parallel to the short sides S1 and S3 of the main frame 100 is referred to as a third direction D3, and an other direction substantially parallel to the short sides S1 and S3 of the main frame 100, opposite to the third direction D3, is referred to as a fourth direction D4. A thickness direction of the main frame 100 is referred to as a fifth thickness D5. The first and second directions D1 and D2 cross (e.g., are substantially perpendicular to) the third and fourth directions D3 and D4, and the fifth direction D5 crosses (e.g., is substantially perpendicular to) the first to fourth directions D1 to D4. The main frame 100 has relatively high thermal resistance and relativity high strength and may be formed of, for example, aluminum and/or stainless steel.

The object film 10 includes fifth, sixth, seventh, and eighth sides S5, S6, S7, and S8 respectively corresponding to the first, second, third, and fourth sides S1, S2, S3, and S4 in a one-to-one correspondence, and the fifth, sixth, seventh, and eighth sides S5, S6, S7, and S8 are stretched in the first, third, second, and fourth directions D1, D3, D2, and D4, respectively. The first to fourth fixing units 210 to 240 are at (e.g., disposed along) the first to fourth sides S1 to S4 of the main frame 100, respectively, to couple (e.g., fix or attach) the object film 10, stretched in the first to fourth directions D1 to D4, to the main frame 100.

The first and third fixing units 210 and 230 extend in the third direction D3 and are disposed along the first and third sides S1 and S3 of the main frame 100, respectively, and the second and fourth fixing units 220 and 240 extend in the first direction D1 and are disposed along the second and fourth sides S2 and S4 of the main frame 100, respectively. The first to fourth fixing units 210 to 240 fix the object film 10 to the first to fourth sides S1 to S4 of the main frame 100, respectively. For example, the fifth side S5 of the object film 10, which extends in the third direction D3 and corresponds to the first side S1 of the main frame 100, is fixed or attached to the first side S1 by the first fixing unit 210. The sixth side S6 of the object film 10, which extends in the first direction D1 and corresponds to the second side S2 of the main frame 100, is fixed or attached to the second side S2 by the second fixing unit 220. The seventh side S7 of the object film 10, which extends in the third direction D3 and corresponds to the third side S3 of the main frame 100, is fixed or attached to the third side S3 by the third fixing unit 230. The eighth side S8 of the object film 10, which extends in the first direction D1 and corresponds to the fourth side S4 of the main frame 100, is fixed to the fourth side S4 by the fourth fixing unit 240.

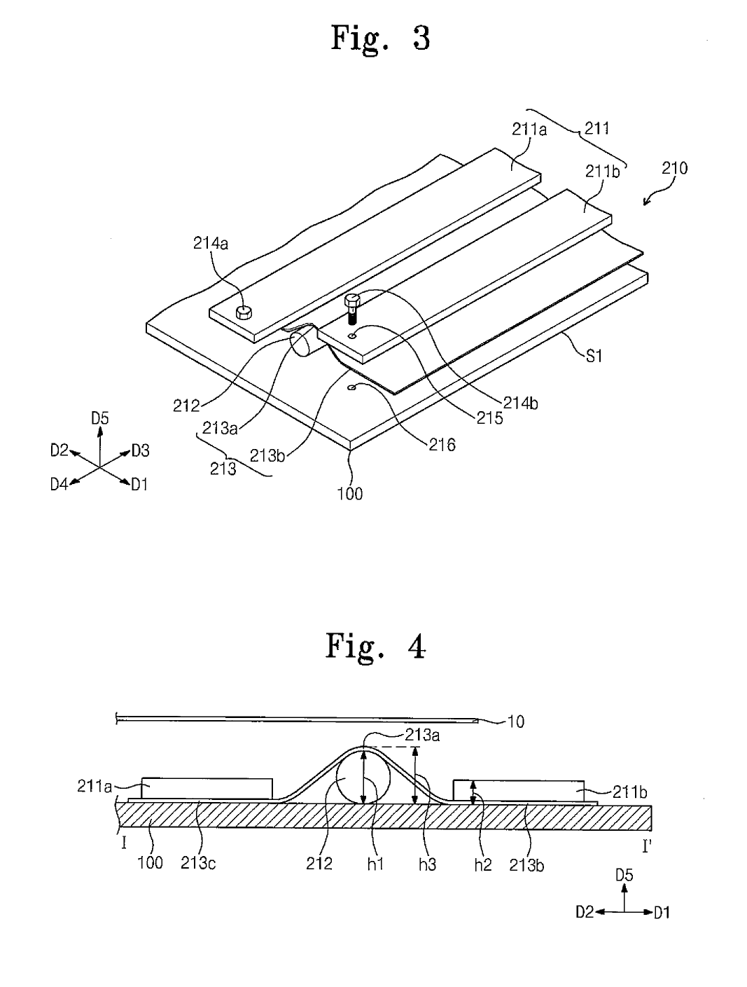

FIG. 3 is an enlarged perspective view showing the first fixing unit 210 shown in FIG. 2, and FIG. 4 is a cross-sectional view taken along the line I-I′ of FIG. 2. The first to fourth fixing units 210 to 240 have substantially the same or the same structure and/or function, and thus, the first fixing unit 210 will be described in detail as a representative example.

The first fixing unit 210 includes a fixing cover 211, a protruding bar 212, an adhesive film 213, and a coupling bolt 214. The fixing cover 211 includes first and second sub-fixing covers 211a and 211b, which extend in the third direction D3. The first and second sub-fixing covers 211a and 211b extend in the third direction D3 and face the upper surface of the main frame 100. As an example, the first and second sub-fixing covers 211a and 211b have relatively high thermal resistance and relatively high strength and may be formed from aluminum and/or stainless steel.

The first and second sub-fixing covers 211a and 211b are disposed on the main frame 100 and spaced from (e.g., spaced apart from) each other by a distance (e.g., a predetermined distance) in the first direction D1. The adhesive film 213 includes a first fixing portion 213b disposed between the second sub-fixing cover 211b and the main frame 100, a second fixing portion 213c disposed between the first sub-fixing cover 211a and the main frame 100, and an adhesive portion 213a disposed between the first fixing portion 213b and the second fixing portion 213c.

The coupling bolts 214 include first and second coupling bolts 214a and 214b. The first and second sub-fixing covers 211a and 211b are coupled to the main frame 100 by the first and second coupling bolts 214a and 214b to couple (e.g., to fix) the adhesive film 213 to the main frame 100. For instance, the second sub-fixing cover 211b is provided with a first opening 215 (e.g., a first hole) formed therethrough corresponding to the second coupling bolt 214b, and the main frame 100 is provided with a second opening 216 (e.g., a second hole) formed therethrough corresponding to the first opening 215. Therefore, when the second coupling bolt 214b is coupled to the first and second openings 215 and 216, the second sub-fixing cover 211b is coupled to (e.g., fixed or attached to) the main frame 100. Similarly, the first sub-fixing cover 211a is coupled to (e.g., fixed or attached to) the main frame 100 by the first coupling bolt 214a.

The first and second openings 215 and 216 are disposed spaced from the adhesive film 213 (e.g., the first and second openings 215 and 216 do not overlap the adhesive film 213). One end of the first and second sub-fixing covers 211a and 211b extends in the first direction D1 (e.g., the one end of the first and second sub-fixing covers 211a and 211b extends parallel to the adhesive film 213) apart from the adhesive film 213, which is disposed adjacent to the one end of the first and second sub-fixing covers 211a and 211b. Thus, the one end of the first and second sub-fixing covers 211a and 211b does not overlap the adhesive film 213. The first and second openings 215 and 216 are disposed at (e.g., near) the one end of the first and second sub-fixing covers 211a and 211b. Accordingly, the first and second coupling bolts 214a and 214b do not penetrate through the adhesive film 213 even though the second bolt 214b is coupled to the first and second openings 215 and 216.

The protruding bar 212 is disposed between the first and second sub-fixing covers 211a and 211b when viewed in a plan view and extends in the third direction D3 (e.g., the protruding bar 212 extends substantially parallel with the first and second sub-fixing covers 211a and 211b). The protruding bar 212 is disposed between the adhesive portion 213a of the adhesive film 213 and the main frame 100 to allow the adhesive portion 213a to be above (e.g., protruded upwardly more than) an upper surface of the first and second sub-fixing covers 211a and 211b. In the present example embodiment, a surface of the protruding bar 212 which makes contact with a lower surface of the adhesive portion 213a has a convex shape in relation to the object film 10 such that the adhesive portion 213a is protruded in a round or curved shape. For instance, the protruding bar 212 may have a circular column shape extending in the third direction D3, but the shape of the protruding bar 212 should not be limited to the circular column shape.

A first height h1 from the upper surface of the main frame 100 to an upper surface of the protruding bar 212 is greater (e.g., higher) than a second height h2 from the upper surface of the main frame 100 to the upper surface of the first and second sub-fixing covers 211a and 211b.

The adhesive portion 213a of the adhesive film 213 is over (e.g., covers) the protruding bar 212 and extends in the third direction D3 (e.g., the adhesive portion 213a extends along the protruding bar 212). The upper surface of the adhesive portion 213a is above (e.g., protruded upwardly more than) the upper surface of the first and second sub-fixing covers 211a and 211b due to the protruding bar 212. Accordingly, a third height h3 from the upper surface of the main frame 100 to the upper surface of the adhesive portion 213a is greater than the second height h2 from the upper surface of the main frame 100 to the upper surface of the first and second sub-fixing covers 211a and 211b.

When the object film 10 is disposed on the main frame 100, the adhesive portion 213a of the adhesive film 213 faces the object film 10. Then, the adhesive film 213 is adhered to the object film 10 by, for example, a welding process. Therefore, the object film 10 is fixed to the first fixing unit 210, and thus, the object film 10 is fixed to the main frame 100. In the present example embodiment, the welding process is performed by an ultrasonic welding process.

The adhesive film 213 may include a material that does not have an adhesive property. In this case, the adhesive film 213 is adhered to the object film 10 by, for example, the welding method. The adhesive film 213 may have substantially the same or the same material as that of the object film 10. When the adhesive film 213 and the object film 10 have the same material, adhesive force and welding uniformity between the adhesive film 213 and the object film 10 may be improved.

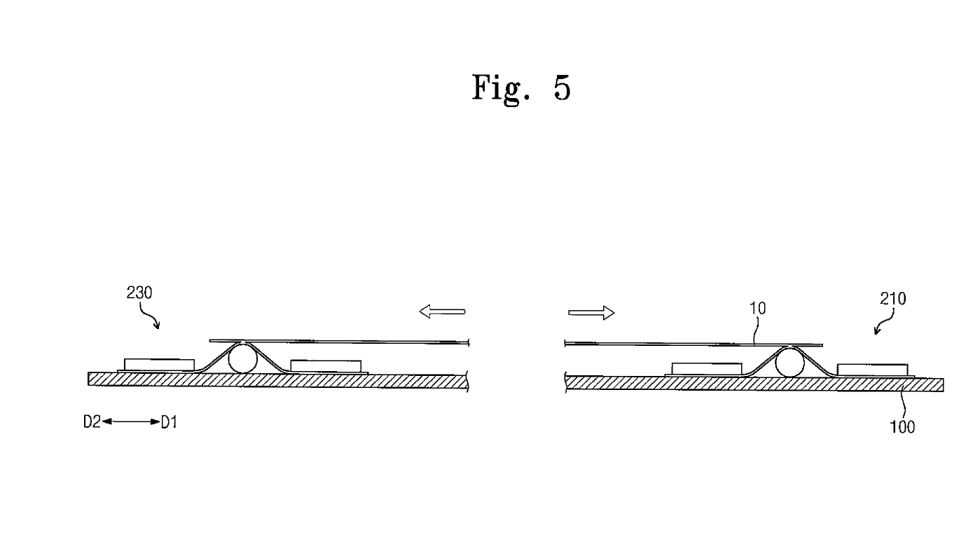

FIG. 5 is a side view showing a tray assembly according to an example embodiment illustrating an object film fixed to a main frame.

Referring to FIG. 5, the object film 10 is coupled to (e.g., fixed to) the first and third fixing units 210 and 230 after being stretched. For example, the object film 10 is stretched in the first and second directions D1 and D2 and welded to the first and third fixing units 210 and 230 by the ultrasonic welding process.

The object film 10 is also stretched in the third and fourth directions D3 and D4, and the sides of the object film 10, which respectively correspond to the second and fourth sides S2 and S4 of the main frame 100, are respectively welded to the second and fourth fixing units 220 and 240 by the ultrasonic welding process.

A first force that stretches the object film 10 along the first and second directions D1 and D2 may be different from a second force that stretches the object film 10 in the third and fourth directions D3 and D4. According to another example embodiment, the first force may be greater than the second force.

As described above, when the stretched object film 10 is coupled to (e.g., fixed to) the main frame 100 by the adhesive film 213, the object film 10 may be stably and uniformly stretched and maintained.

That is, because the object film 10 is welded to the main frame 100 by the adhesive film 213, the object film 10 is stably fixed to the main frame 100, thereby preventing the object film 10 from being curved and/or sagging during the transfer layer forming process and/or the lamination process. In addition, because each side of the object film 10 is welded (e.g., continuously or completely welded) to the adhesive film 213 along the first and third directions D1 and D3, a stress occurring in the object film 10 becomes uniform, and the object film 10 is effectively prevented from being wrinkled.

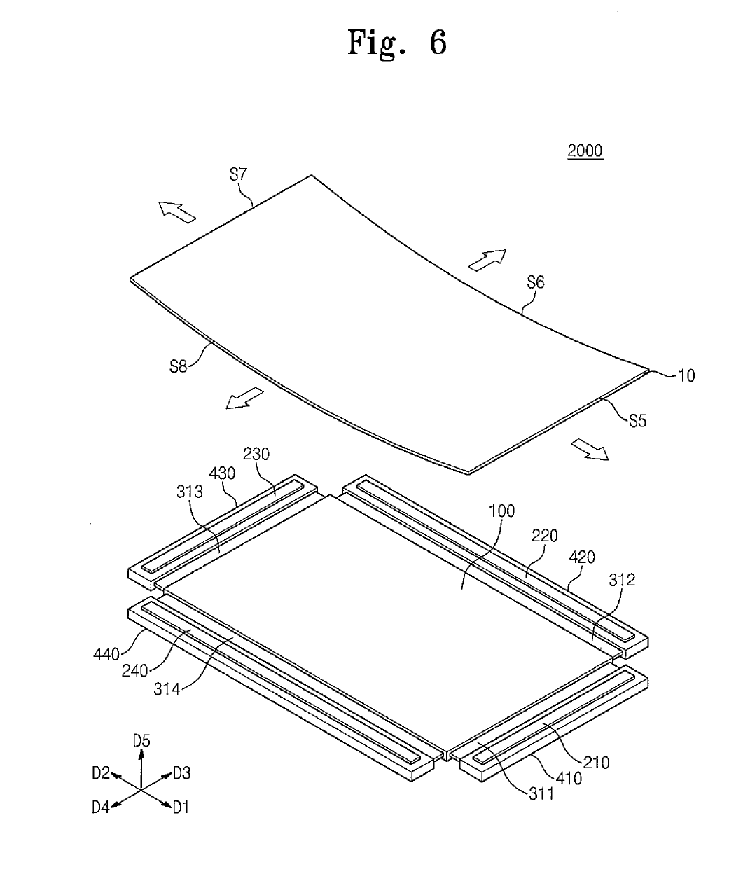

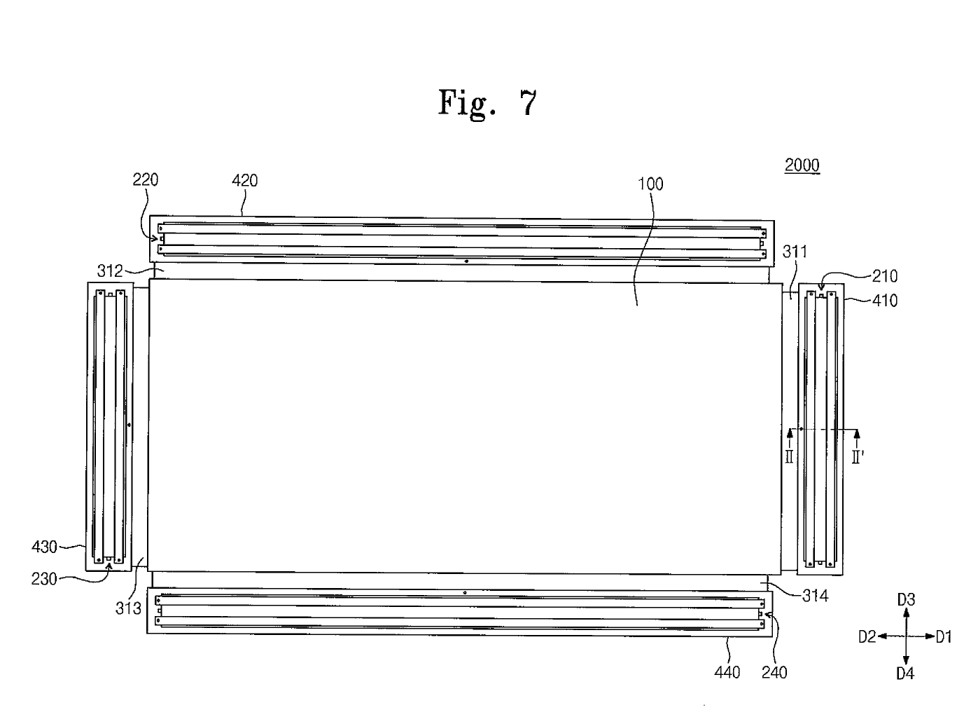

FIG. 6 is a perspective view showing a tray assembly according to another example embodiment of the present disclosure, and FIG. 7 is a plan view showing the tray assembly shown in FIG. 6.

Referring to FIGS. 6 and 7, a tray assembly 2000 includes a main frame 100, first, second, third, and fourth fixing units 210, 220, 230, and 240, first, second, third, and fourth coupling parts 311, 312, 313, and 314, and first, second, third, and fourth stretching units 410, 420, 430, and 440.

The object film 10, the main frame 100, and the first to fourth fixing units 210 to 240 have substantially the same or the same structure and/or function as those of the object film 10, the main frame 100, and the first to fourth fixing units 210 to 240 shown in FIGS. 1 to 5, and detailed descriptions thereof may be omitted.

The first to fourth coupling parts 311 to 314 are respectively protruded outward from the first to fourth sides S1 to S4 of the main frame 100. The first to fourth coupling parts 311 to 314 each have a rectangular shape. The first to fourth coupling parts 311 to 314 have a thickness less than that of the main frame 100. The first coupling part 311 is protruded from the first side S1 of the main frame 100 in the first direction D1 and extends in the third direction D3 (e.g., extends parallel to the first side S1). The second coupling part 312 is protruded from the second side S2 of the main frame 100 in the third direction D3 and extends in the first direction D1 (e.g., extends parallel to the second side S2). The third coupling part 313 is protruded from the third side S3 of the main frame 100 in the second direction D2 and extends in the third direction D3 (e.g., extends parallel to the third side S3). The fourth coupling part 314 is protruded from the fourth side S4 of the main frame 100 in the fourth direction D4 and extends in the first direction D1 (e.g., extends parallel to the fourth side S4).

The first to fourth coupling parts 311 to 314 have relatively high thermal resistance and relatively high strength and may be formed of aluminum and/or stainless steel.

The first to fourth coupling parts 311 to 314 are coupled to (e.g., connected to) the first to fourth stretching units 410 to 440, respectively.

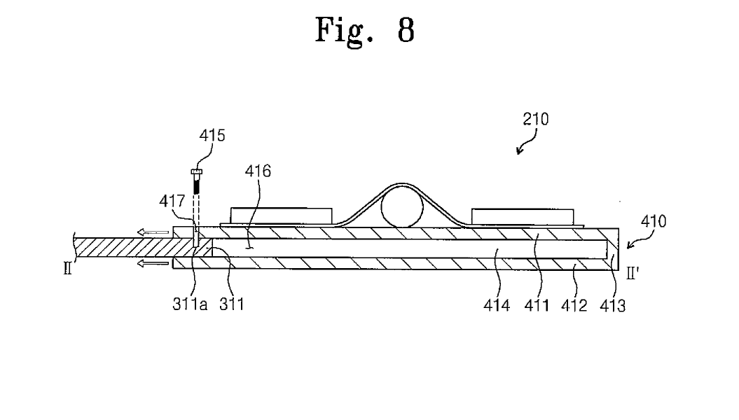

FIG. 8 is a cross-sectional view taken along the line II-II′ of FIG. 7. In the present example embodiment, the first to fourth stretching units 410 to 440 have substantially the same or the same structure and/or function, and thus, the first stretching unit 410 will be described in detail with reference to FIG. 8 as a representative example.

Referring to FIG. 8, the first stretching unit 410 includes an upper wall 411 extending in the first direction D1, a lower wall 412 extending in the first direction D1, and a sidewall 413 extending in the fifth direction D5. The upper and lower walls 411 and 412 face each other, and the sidewall 413 is disposed between the upper and lower walls 411 and 412 to couple (e.g., to connect) the upper and lower walls 411 and 412. The upper wall 411, the sidewall 413, and the lower wall 412 form a coupling recess 416 into which the first coupling part 311 is inserted.

The first stretching unit 410 is coupled to (e.g. mechanically coupled or connected to) the first coupling part 311 such that the first stretching unit 410 moves in the first direction D1 or the second direction D2. The first stretching unit 410 has the coupling recess 416 formed by the upper and lower walls 411 and 412 and a hitch unit which prevents the first stretching unit 410 from separating from the first coupling part 311.

The first coupling part 311 is inserted to the coupling recess 416 and guides the movement of the first stretching unit 410 along the first and second direction D1 and D2. In this case, the upper and lower walls (411, 412) slide over the first coupling part 311 and move in the first and second direction D1 and D2.

When the first stretching unit 410 moves a reference distance (e.g., a certain or predetermined distance) in the first direction D1, the hitch unit prevents the first stretching unit 410 from moving further in the first direction D1 to prevent the first stretching unit 410 from separating from the first coupling part 311.

For example, the upper and lower walls 411 and 412 guide the first coupling part 311 that slides or moves in the first direction D1 or the second direction D2.

The first stretching unit 410 includes a first fixing opening 417 (e.g., a first fixing hole). The first fixing opening 417 is formed by removing a portion of the first stretching unit 410. The first coupling part 311 includes a second fixing opening 311a (e.g., a second fixing hole) formed at upper portion of the first coupling portion 311. The second fixing opening 311a is formed at a position corresponding to the first fixing opening 417 when the first stretching unit 410 moves in the first direction D1 to stretch the object film 10.

The first stretching unit 410 includes a fixing bolt 415. The fixing bolt 415 is coupled to the first and second fixing openings 417 and 311a. When the fixing bolt 415 is tightened, the first stretching unit 410 is coupled to (e.g., fixed to) the first coupling part 311, and the first stretching unit 410 does not move relative to the first coupling part in the first direction D1 or the second direction D2.

The third stretching unit 430 is coupled to (e.g., mechanically coupled or connected to) the main frame 100 such that the third stretching unit 430 is coupled to the third coupling part 313 and moves in the first direction D1 or the second direction D2. The second and fourth stretching units 220 and 240 are coupled to (e.g., mechanically coupled or connected to) the main frame 100 such that the second fourth stretching units 220 and 240 are respectively coupled to the second and fourth coupling parts 312 and 314 and move in the third direction D3 or the fourth direction D4. Additionally, the third stretching unit 430 may include the coupling space and hitch unit.

The tray assembly 2000 may further include a transfer part. The transfer part is coupled to (e.g., connected to) the first to fourth stretching units 410 to 440 to move the first to fourth stretching units 410 to 440.

Referring to FIG. 7 again, the first to fourth fixing units 210 to 240 couple (e.g., fix) the object film 10 to the first to fourth stretching units 410 to 440. For example, the first fixing unit 210 is disposed at a position corresponding to the first stretching unit 410 to couple (e.g., fix) the fifth side S5 of the object film 10 to the first stretching unit 410. The second fixing unit 220 is disposed at a position corresponding to the second stretching unit 420 to couple (e.g., fix) the sixth side S6 of the object film 10 to the second stretching unit 420. The third fixing unit 230 is disposed at a position corresponding to the third stretching unit 430 to couple (e.g., fix) the seventh side S7 of the object film 10 to the third stretching unit 430. The fourth fixing unit 240 is disposed at a position corresponding to the fourth stretching unit 440 to couple (e.g., fix) the eighth side S8 of the object film 10 to the fourth stretching unit 440.

As described above, the object film 10 may be welded to the adhesive film 213 of each of the first to fourth fixing units 210 to 240 by, for example, the ultrasonic welding process.

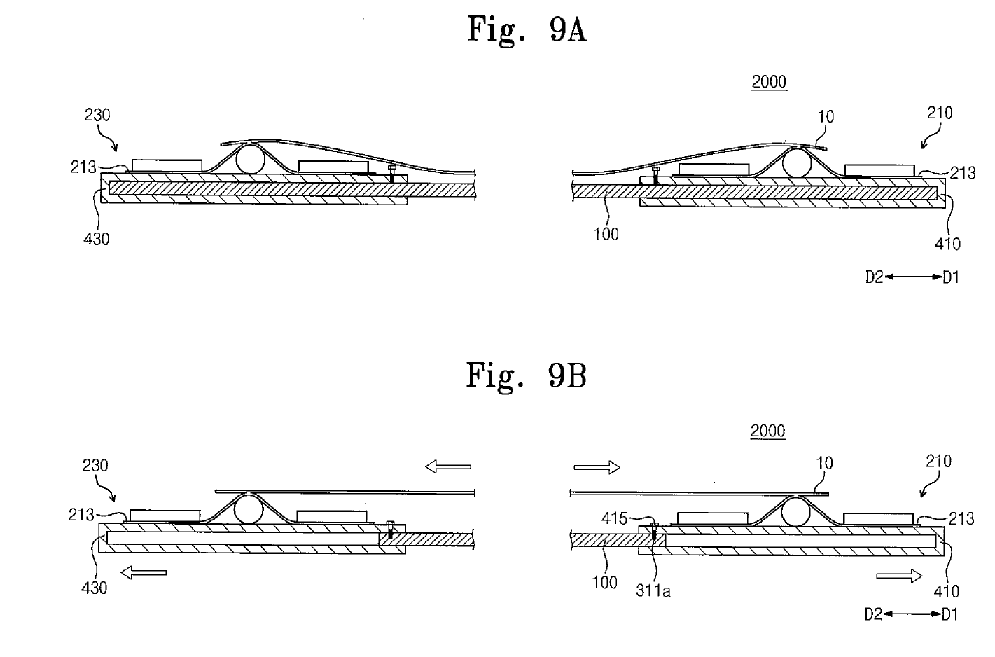

FIG. 9A is a side view showing an initial state of a tray assembly according to another example embodiment of the present disclosure, and FIG. 9B is a side view showing a stretched state of a tray assembly according to another example embodiment of the present disclosure.

Referring to FIG. 9A, the tray assembly 2000 does not stretch the object film 10 during an initial state. The object film 10 is coupled or adhered to the adhesive film 213 of the fixing units 210 and 230. Because the object film 10 is not stretched, a center portion of the object film 10 sags when the object film 10 is fixed to the fixing units 210 and 230.

Referring to FIG. 9B, the first stretching unit 410 moves in the first direction D1 and the third stretching unit 430 moves in the second direction D2, and thus, the object film 10 is stretched in the first and second directions D1 and D2.

The second stretching unit 420 moves in the third direction D3 and the fourth stretching unit 440 moves in the fourth direction D4 after the object film 10 is stretched in the first and second directions D1 and D2, and thus, the object film 10 is stretched in the third and fourth directions D3 and D4.

A first force that stretches the object film 10 in the first and second directions D1 and D2 may be different from a second force that stretches the object film 10 in the third and fourth directions D3 and D4. According to another example embodiment, the first force may be greater than the second force.

The fixing bolt 415 is placed at a position corresponding to the second fixing opening 311a after the object film 10 is stretched. In the stretched state object film, the object film 10 is contracted by the stress thereof. The fixing bolt 415 is coupled to the second fixing opening 311a and fixes the first and third stretching units 410 and 430 to the first and second fixing units 311 and 313, respectively, to thereby maintain the stretched state of the object film 10.

Then, the transfer layer formed of the organic material is formed on the stretched object film 10 through, for example, the transfer layer forming process to complete the donor film.

According to the above, because the object film 10 is coupled to (e.g., welded to) the main frame 100 by the adhesive film 213, the object film 10 is stably fixed to the main frame 100. Therefore, the object film 10 may be prevented from being curved or sagging when the lamination and laser induced thermal imaging processes are performed as the subsequent processes. In addition, the object film 10 is coupled to (e.g., continuously coupled or welded to) the adhesive film 213 along the third direction D3, and thus, the stress occurring on the object film 10 becomes uniform. Thus, the object film 10 may be effectively prevented from being wrinkled.

Further, the tray assembly 2000 may effectively stretch the object film 10 because the object film 10 is stretched by the first to fourth stretching units 410 to 440 after being adhered to the adhesive film 213.

Although the example embodiments of the present invention have been described herein, it is understood that the present invention should not be limited to these example embodiments but various changes and modifications can be made by one ordinary skilled in the art within the spirit and scope of the present invention as hereinafter claimed and equivalents thereof.

What is claimed is:

1. A tray assembly configured to stretch an object film, the tray assembly comprising:
a main frame on which the object film is placed; and
a fixing unit along sides of the main frame and configured to couple the object film to the main frame,
wherein the fixing unit comprises an adhesive film coupled to the object film thereby coupling the object film to the main frame.

2. The tray assembly of claim 1, wherein the adhesive film is coupled to the object film by a welding process.

3. The tray assembly of claim 2, wherein the welding process comprises an ultrasonic welding process.

4. The tray assembly of claim 2, wherein the adhesive film comprises a same material as the object film.

5. The tray assembly of claim 1, wherein the fixing unit further comprises a fixing cover facing the main frame,
and wherein the adhesive film comprises:
a fixing portion between and coupled to the main frame and the fixing cover; and
an adhesive portion comprising an upper surface coupled to the object film.

6. The tray assembly of claim 5, wherein the fixing unit further comprises a protruding bar under the adhesive portion of the adhesive film, and
wherein the adhesive portion of the adhesive film is above an upper surface of the fixing cover.

7. The tray assembly of claim 6, further comprising a stretching unit,
wherein the stretching unit is configured to stretch the object film in a first direction and a second direction opposite to the first direction,
wherein the protruding bar and the adhesive portion of the adhesive film extend in a third direction substantially perpendicular to the first direction, and
wherein the object film is coupled to the adhesive portion along the third direction.

8. The tray assembly of claim 7, wherein the fixing cover comprises first and second sub-fixing covers extending in the third direction and spaced from each other,
wherein the protruding bar is between the first and second sub-fixing covers, and
wherein the fixing portion of the adhesive film comprises a first fixing portion covered by the first sub-fixing cover and a second fixing portion covered by the second sub-fixing cover.

9. The tray assembly of claim 8, wherein the protruding bar contacts the adhesive portion of the adhesive film and has a curved surface object film.

10. The tray assembly of claim 1, wherein the main frame has a rectangular shape with first, second, third, and fourth sides, and
wherein the fixing unit comprises first, second, third, and fourth fixing units at the first, second, third, and fourth sides of the main frame, respectively.

11. The tray assembly of claim 1, further comprising a stretching unit at an outer position of each of the sides of the main frame, the stretching units at opposite ones of the sides facing each other, and mechanically coupled to the main frame,
wherein the stretching unit is configured to be movable, and
wherein the fixing unit is on the stretching unit.

12. The tray assembly of claim 11, wherein the main frame has a rectangular shape with first, second, third, and fourth sides,
wherein the stretching unit comprises first and second stretching units at the first and second sides of the main frame, facing each other, and configured to move in a first direction and a second direction opposite to the first direction, and
wherein the fixing unit is at each of the first and second stretching units.

13. The tray assembly of claim 12, wherein the stretching unit further comprises third and fourth stretching units at the third and fourth sides of the main frame, facing each other, and configured to move in a third direction and a fourth direction opposite to the third direction, and
wherein the fixing unit is at each of the third and fourth stretching units.

14. The tray assembly of claim 1, wherein the object film comprises a laser induced thermal imaging donor film coated by a transfer material.

15. A method of manufacturing a donor film, the method comprising:
placing an object film on a main frame of a tray assembly;
stretching the object film; and
coupling the object film to a fixing unit at sides of the main frame,
wherein the coupling of the object film comprises coupling an adhesive film on the fixing unit to the object film thereby coupling the object film to the main frame.

16. The method of claim 15, wherein the coupling of the object film to the adhesive film comprises an ultrasonic welding process.

17. The method of claim 16, wherein the adhesive film comprises a same material as the object film.

18. The method of claim 15, wherein the object film is stretched in a first direction, a second direction opposite to the first direction, a third direction substantially perpendicular to the first direction, and a fourth direction opposite to the third direction object film.

19. The method of claim 18, wherein the main frame comprises first sides extending in the first and second directions and second sides extending in the third and fourth directions, and a force stretching the object film in the first and second directions is greater than a force stretching the object film in the third and fourth directions, and
wherein the first sides are longer than the second sides.

20. The method of claim 19, wherein the tray assembly further comprises a stretching unit at an outer position of each of the sides of the main frame, mechanically coupled to the main frame, and configured to be moveable,
wherein the fixing unit is on the stretching unit and the object film is stretched by moving the stretching unit.
